(19) United States
(12) Patent Application Publication
(10) Pub. No.: US 2023/0031145 A1
(43) Pub. Date: Feb. 2, 2023

(54) ACCIDENTAL VOICE TRIGGER AVOIDANCE USING THERMAL DATA

(71) Applicant: Comcast Cable Communications, LLC, Philadelphia, PA (US)

(72) Inventor: Ganesh Narayanan, Chennai (IN)

(21) Appl. No.: 17/388,673

(22) Filed: Jul. 29, 2021

(51) Int. Cl. G10L 15/22; H04R 1/40; H04R 3/00; G10L 15/08; G10L 15/24; G06K 9/00; G06K 9/20; G06T 7/70

(52) U.S. Cl. CPC G10L 15/22; H04R 1/406; H04R 3/005; G10L 15/08; G10L 15/24; G06K 9/00362; G06K 9/209; G06T 7/70; G10L 2015/088; G10L 2015/223; G06T 2207/10048; G06T 2207/30196

(57) ABSTRACT

Methods and systems for processing voice commands are disclosed. A voice controlled device may receive audio data comprising a voice command. Location information indicative of the source of the audio data may be determined. One or more devices may be caused to determine signals based on the location information. The one or more devices may receive thermal data in response to the signals. The thermal data may be analyzed to determine if the thermal data indicates the presence of a person at the expected location. If a person is detected, then the audio data may processed to cause the voice command to be executed.

### BACKGROUND

Voice controlled devices allow users to provide commands without having to use conventional input devices, such as keyboards, which may be slow and cumbersome to use. A voice controlled device may be triggered by hearing a keyword regardless of whether the keyword comes from a persons or conversations played back on a television or other audio device. Thus, there is a need for more sophisticated devices that can discern whether a detected sound was generated by a human or played from a device.

### SUMMARY

Methods and systems for processing voice commands are disclosed. A voice controlled device may receive audio data including a voice command. In some cases, the audio may be generated by a person attempting to give a command to the voice controlled device. In other cases, a sound from a television, computer, or other device may sound similar or the same as a person attempting to give the command. The voice controlled device may determine whether the audio data is indicative of user input from a user nearby by using a thermal signature to determine whether a person is located near the voice controlled device. If audio data is received, a direction of the source of the audio data and/or other location information indicative of the source may be determined. One or more devices may be caused to detect signals based on the location information, such as in the direction of a predicted location. The one or more devices may receive thermal data in response to the signals. The thermal data may be analyzed to determine if the thermal data indicates the presence of a person at the expected location. If a person is detected, then the audio data may be processed to execute any voice commands in the audio data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows a block diagram of an example system for communication.

FIG. 2A shows a diagram of an example process for processing a voice command.

FIG. 2B shows a diagram of an example process for processing a voice command.

FIG. 3 shows a flowchart of an example method.

FIG. 4 shows a flowchart of an example method.

FIG. 5 shows a flowchart of an example method.

FIG. 6 is a block diagram illustrating an example computing device.

### DETAILED DESCRIPTION OF ILLUSTRATIVE EMBODIMENTS

Methods and systems for processing a voice command are disclosed. An example computing device may receive audio data from a source, such as a human or non-human source (e.g., speaker). Beamforming and/or other spatial processing may be used to identify location information indicative of the location of the source, such as a direction of the source. Thermal imaging signals may be detected in the direction of the source. In some cases, thermal imaging signals may be emitted towards the location of the source (e.g., to increase imaging performance). Cameras with infrared sensors and emitters (e.g., along with conventional imaging capabilities) may be controlled to emit the signals and/or receive thermal data. Other signal emitters may be used, such as long distance infrared emitters, lasers emitters, and/or the like may be used in addition to infrared cameras. The thermal data may be analyzed to determine one or more thermal signatures. The one or more thermal signatures may be analyzed to determine if any of the thermal signatures are indicative of a human instead of machine. If a thermal signature is determined to be indicative of a human, any voice commands in the original audio may be processed. Otherwise, the audio may be ignored.

A machine learning model may be used to analyze thermal imaging data and/or other information to determine thermal signatures, categorize a thermal signature as human or non-human, identify a specific user based on a thermal signature, or a combination thereof. The machine learning model may be able to analyze more challenging thermal data in which the object may be close but not in direct range of thermal measurement (e.g., a conversation which initiated in a direct range and identified as “human”, but now not in range, may still treat the trigger word as valid).

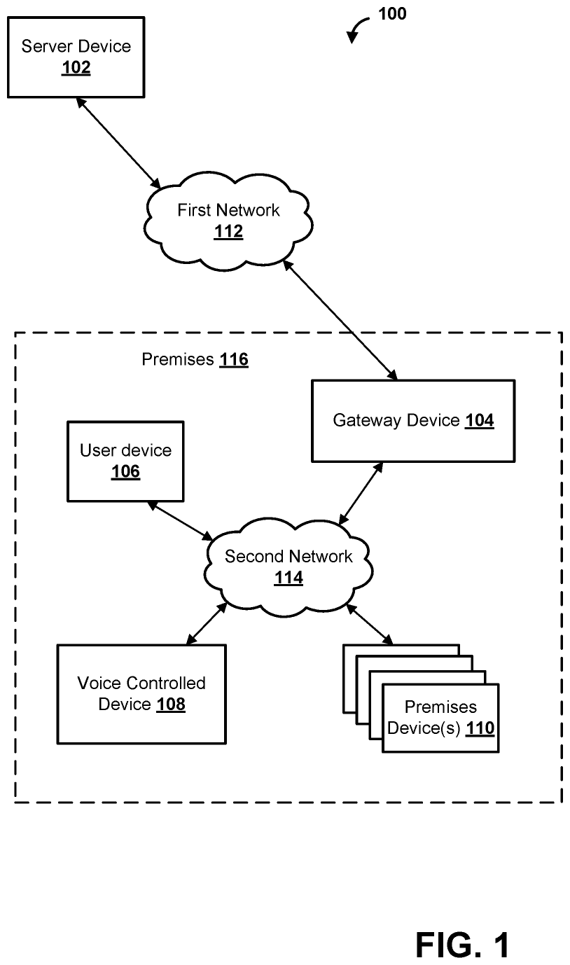

FIG. 1 shows a block diagram of an example system 100 for communication. The system 100 may comprise a server device 102, a gateway device 104, a user device 106, a voice controlled device 108, one or more premises devices 110. It should be noted that while the singular term device is used herein, it is contemplated that some devices may be implemented as a single device or a plurality of devices (e.g., via load balancing). The server device 102, the gateway device 104, the user device 106, the voice controlled device 108, the one or more premises devices 110, may each be implemented as one or more computing devices. Any device disclosed herein may be implemented using one or more computing nodes, such as virtual machines, executed on a single device and/or multiple devices.

The server device 102, the gateway device 104, the user device 106, the voice controlled device 108, the one or more premises devices 110, may be communicatively coupled via one or more networks, such as a first network 112 (e.g., a wide area network) and one or more second networks 114 (e.g., one or more local area networks). The first network 112 may comprise a content distribution and/or access network. The first network 112 may facilitate communication via one or more communication protocols. The first network 112 may comprise fiber, cable, a combination thereof. The first network 112 may comprise wired links, wireless links, a combination thereof, and/or the like. The first network 112 may comprise routers, switches, nodes, gateways, servers, modems, and/or the like.

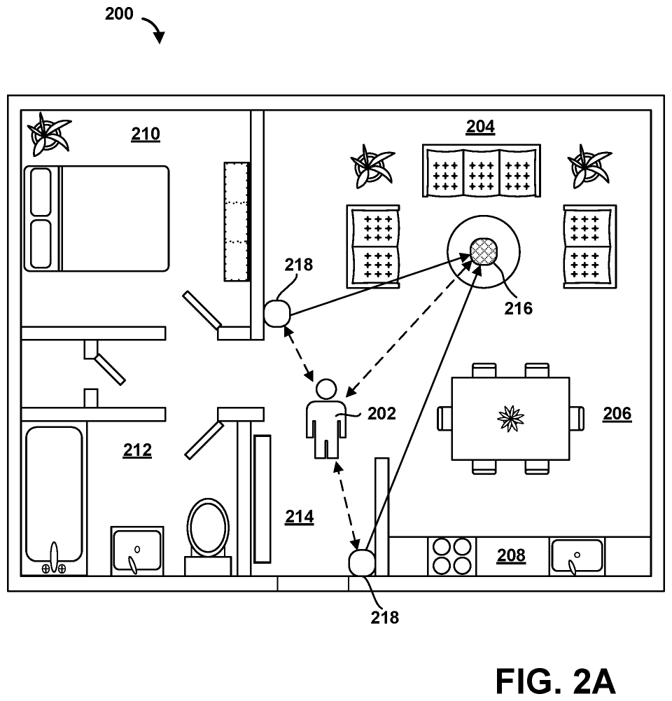

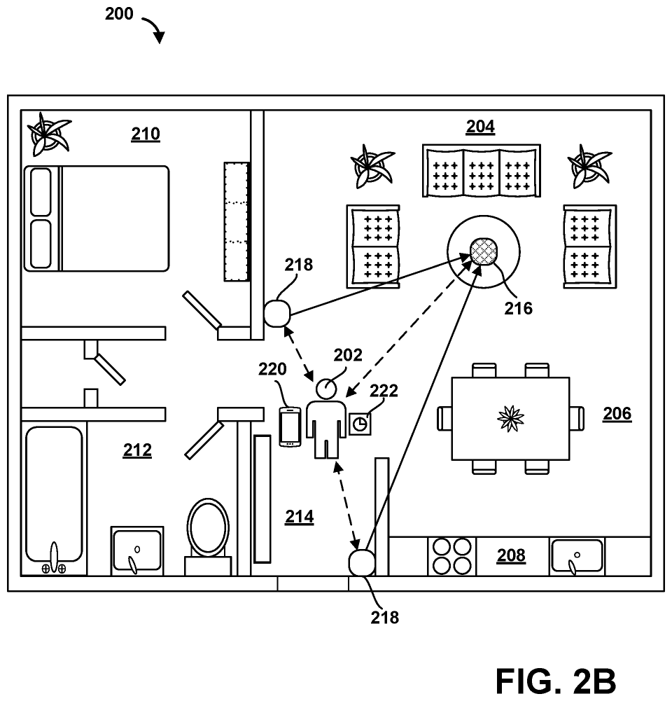

The one or more second networks 114 may comprise one or more networks in communication with the gateway device 104 and/or the voice controlled device 108. In some scenarios, the gateway device 104 and the voice controlled device 108 may be implemented as a single device. The one or more second networks 114 may comprise one or more networks at a premises 116. The premises 116 may be a customer premises. The premises 116 may include an area within a coverage range (e.g., wireless range) of the gateway device 104 (e.g., or voice controlled device 108). The premises 116 may comprise a property, dwelling, terminal, building, floor, and/or the like. The premises 116 may comprise different rooms, walls, door, windows, and/or the like (e.g., as shown in FIG. 2). The user device 106 may move within the premises 116 and/or outside of the premises.

The one or more premises devices 110 may be located at the premises 116. The one or more premises devices 110 may comprise one or more of a camera, a sensor, a security system, a security controller, a gateway device, a smoke detector, a heat sensor, infrared sensor, infrared emitter, infrared camera, a door sensor, a motion sensor, a window sensor, a thermostat, a microphone, a personal assistant, a door lock, an irrigation device, or a combination thereof. The one or more premises devices 110 may be configured to generate premises data. The premises data may comprise a sensor state, a setting, audio, video, images, text information, premises mode, or a combination thereof. The premises data may comprise thermal data, such as heat sensor data, data of an infrared sensor (e.g., data for each of a plurality of pixels of the sensor), a thermal signature, a combination thereof, and/or the like. The one or more premises devices 110 may be configured to send the premises data to the server device 102, the user device 106, the gateway device 104, the voice controlled device 108, or a combination thereof.

The server device 102 may be configured to provide one or more services, such as account services, application services, network services, content services, or a combination thereof. The server device 102 may comprise services for one or more applications on the user device 106. The server device 102 may generate application data associated with the one or more application services. The application data may comprise data for a user interface, data to update a user interface, data for an application session associated with the user device 106, and/or the like. The application data may comprise data associated with access, control, and/or management of the premises 116. The application data may comprise the premises data, updates to the premises data, and/or the like.

The server device 102 may be configured to determine to send information (e.g., configuration settings, notifications, information about the premises) to the user device 106, the gateway device 104, or a combination thereof. The server device 102 may comprise information rules associating various values, patterns, account information, and/or the like with corresponding information. The server device 102 may detect a change in the premises data from the one or more premises devices. The server device 102 may analyze the premises data and determine that an information rule is triggered. The information may be sent to the user device 106 based on the information rule being triggered and/or satisfied. The information may comprise at least a portion of the premises data, such as an image, video, sensor state (e.g., motion detected, window open, window closed, door open, door closed, temperature, measured particle level, smoke detected, heat detected) and/or the like. The information may comprise a configuration setting of the gateway device 104, the voice controlled device 108, the user device 106, the one or more premises devices 110.

The voice controlled device 108 may comprise a smart speaker, such as a device comprising a speaker, a computer processor (e.g., or micro-controller), and a microphone. The voice controlled device 108 may be configured to receive voice commands from users at the premises 116. Voice commands may comprise any command, such as buying a product, adding an item to a list, playing music, providing an answer to a question (e.g., via querying a search engine), and/or the like.

The voice controlled device 108 may be configured to receive captured audio data. The voice controlled device 108 may comprise one or more microphones, such as an array of microphones. The voice controlled device 108 may be configured receive the audio data by capturing the audio data using the one or more microphones. The voice controlled device 108 may be configured to receive audio data captured by the one or more premises devices 110, the user device 106, the gateway device 104, or a combination thereof. These one or more premises devices 110, the user device 106, the gateway device 104, or a combination thereof may send the audio data based on a condition, such as an instruction (e.g., command from the voice controlled device 108), a noise level reaching a threshold level, a schedule of capturing data, detection of a user within a premises (e.g., or room, area, zone), a combination thereof, and/or the like. These one or more premises devices 110, the user device 106, the gateway device 104, or a combination thereof may continuously capture audio data (e.g., in a buffer), but may only send a portion of the data if the condition is satisfied.

The voice controlled device 108 may be configured to determine location information indicative of a location of a source of the audio data. The location information may comprise a direction (e.g., with respect to the voice controlled device 108, the gateway device 104, the one or more premises devices 110, the user device 106), a region (e.g., floor of the premises 116, group of rooms), an area (e.g., area within one or more rooms, patio), a room, or a portion of the room. The voice controlled device 108 may perform spatial processing of the audio data to determine the location.

The voice controlled device 108 may perform the spatial processing based on a plurality of microphones. The plurality of microphones may be microphones from different devices. The plurality of microphones may comprise an array of microphones on one device, such as the voice controlled device 108. The plurality of microphones may comprise multiple arrays of microphones from one or more devices, such as the voice controlled device 108 and the one or more premises devices 110. The voice controlled device 108 may use the plurality of microphones (e.g., the array of microphones) to determine and/or recognize a far field audio input. The plurality of microphones may comprise audio data having different intensities. The voice controlled device 108 may analyze differential intensities of the received signal across the plurality of microphones (e.g., the array of microphones) to determine the direction of the source of the incoming audio.

The voice controlled device 108 may be configured to synchronize and/or coordinate with other devices use to capture audio data and/or other user information. Time stamps in the data may be used to correlate data from the devices to allow for more accurate analysis of the data. The gateway device 104 be an intermediary device that facilitates the synchronization and/or coordination between the voice controlled device 108 and the other devices. The voice enabled device 108 may be configured to use a near field audio detection algorithm, a far field audio detection algorithm, or a combination thereof. Which one of the near field or the far field algorithm is used may depend on a variety of factors, such as the intensity of detected audio, the clarity of the detected audio, the extent to which the data signal can be processed with high accuracy, or a combination thereof. The voice controlled device 108 may use the current location of the voice controlled device 108 as a point of reference on determining the relative direction/location of the audio source.

In some scenarios, the voice controlled device 108 may be configured to obtain other data in addition or instead of the audio data to determine location information. The other data may comprise any data from the user device 106 (e.g., wearable device, mobile phone, content viewing data), the gateway device 104, the one or more premises device 110. The other data may comprise positioning data, such as global positioning systems data, wireless signal based location data (e.g., received signal strength, wireless beam forming data), proximity data (e.g., NFC tags, motion sensor data), usage data (e.g., if a device is in use, the device may have a known location and the user may be predicted to be near the device), lidar data (e.g., from a machine, a robot, a camera, a mobile phone), a combination thereof, and/or the like. This other data may be used to determine the location information, verify the location information from the audio data, refine the location information from the audio data (e.g., if the location is below a threshold probability of accuracy, if the location is above a threshold level of specificity).

The voice controlled device 108 may be configured to cause one or more devices to emit and/or detect one or more infrared signals in the direction of the source. The one or more infrared signals may comprise long-wave infrared (LWIR) (e.g., 8.0-14.0 μm wavelengths), mid-wave infrared (MWIR) (e.g., 3.0-5.0 μm, 3.3-5.0 μm wavelengths), short-wave infrared (SWIR) (e.g., 0.9-1.7 μm, 0.7-2.5 μm wavelengths), or a combination thereof. The one or more devices may comprise the one or more premises devices 110, the user device 106, the gateway device, the voice controlled device 108, or a combination thereof. The one or more devices may be caused, based on the location information (e.g., direction and/or location of the source), to emit and/or detect one or more signals in the direction of the source. The signals may comprise infrared signals, thermal signals, heat signals, and/or the like. The one or more devices that emit and/or detect the infrared signals may comprise one or more of an infrared device, an infrared sensor, an infrared camera, or a video camera. If the one or more devices include an infrared camera, a message may be sent to the camera comprising an instruction to emit and/or detect a signal and to send any detected thermal data (e.g., thermal imaging dating) back to the voice controlled device 108.

The instructions may comprise a signal configuration instruction, such as a beam forming instruction. The signal configuration may cause the signals to be emitted (e.g., or steered) in the determined direction of the source and/or towards a location of the source. The configuration may comprise a range of directions, such as an angle range. In some scenarios, the instructions may instruct the one or more devices to detect signals (e.g., without emitting any signals). The instructions may comprise a signal detection configuration, such as a direction from which to detect signals. The instructions (e.g., signal configuration, signal detection configuration) may comprise a direction, range of directions, angle range, distance (e.g., relative distance from the voice controlled device 108 to another device), range (e.g., angle range, distance range, boundary, boundary range) associated with movement of the source (e.g., if the source is moving).

The one or more devices may receive thermal data. The thermal data may be received based on (e.g., in response to) the instructions to emit and/or detect thermal data. The thermal data may comprise thermal imaging data, such as thermal intensity values for a plurality of pixels of an image and/or sensor. The thermal data may be indicative of a thermal signature associated with the source. The thermal data may be sent to the voice controlled device 108.

The voice controlled device 108 may be configured to analyze the thermal data to determine whether the source is a person, indicative of user input, indicative of a user, or indicative of a non-human source. The thermal data may be analyzed to determine a thermal signature. The thermal signature may be a portion of the thermal data indicative of a device, person, and/or other object. The thermal signature may be determined by performing automated boundary recognition in the thermal data. Boundaries may be determined where intensity values vary more than a threshold amount. The thermal signature (e.g., or thermal data) may be analyzed to determine whether the thermal signature (e.g., or thermal data) is indicative of a user (e.g., indicative of a person, indicative of user input). The thermal signature (e.g., or thermal data) may be indicative of a user (e.g., or user input) if it indicates that the source is a person (e.g., instead of a machine). One or more characteristics of the thermal signature (e.g., or thermal data) may be analyzed to determine whether the thermal signature (e.g., or thermal data) is indicative of a user. The one or more characteristics may comprise a temperature, a shape, a size, a movement, a combination thereof, and/or the like.

The voice controlled device 108 may determine a temperature, a temperature range, an average temperature, and/or the like of the thermal signature. If the temperature, the temperature range, the average temperature, and/or the like match (e.g., within a threshold similarity) an expected temperature, temperature range, average temperature, and/or the like for a person, then the thermal signature may be determined to be indicative of a person. The thermal data and/or thermal signature may have a time dimension, showing changes in the thermal data over time. The changes, movement, and/or movement pattern of the thermal signature may be indicative of a person. The thermal signature may have a shape and/or a collection of shapes. Shapes may be areas of lower or higher intensity values. A pattern of different higher and lower intensity values may be indicative of a person. A face, arm, hand, and/or other part of a person may be detected as higher intensity values. A shirt, pants, and/or other leg and torso areas may have lower intensity values. An example pattern may comprise lower intensity values (e.g., torso areas) in between areas of higher intensity values (e.g., appendage areas). A shape of the thermal signature may be matched to the shape of an arm, head, hand, leg, foot, body, and/or the like.

A machine learning model (e.g., neural network) may be trained to recognize thermal signatures indicative of people. The machine learning model may be stored and/or implemented via the voice controlled device 108 and/or may be accessed via a different device, such as the server device 102, the user device 106, the gateway device 104, or a combination thereof. The machine learning model may perform automated feature recognition to determine features of the thermal signature indicative of a person and/or user input. The machine learning model may be trained using a training data set comprising thermal signatures of a plurality of different people. The machine learning model may be further trained (e.g., refined) based on thermal signatures identified at the premises 116, such as thermal signatures of different users.

The machine learning model may be configured (e.g., trained, refined) based on a variety of inputs, such as thermal signature, thermal signature pattern (e.g., how a pattern changes, similarities in signatures of a particular user, similarities of different people, similarities of non-human signatures), voice profile, and/or other user information (e.g., GPS, location data, movement data, accelerometer data). A thermal signature (e.g., or thermal signature pattern) may comprise a combination of thermal images of the source either in parts or in full. Each of the thermal images may comprise a different view, perspective, part, direction, and/or the like of the source (e.g. person, machine). The machine learning model may receive these inputs at a variety of times, such as before thermal data is detected at the premises 116, after thermal data is detected at the premises 116, after a user is recognized at a premises 116, or a combination thereof. A user may be recognized at a premises 116 based on a variety of information, such as a thermal signature, user behavior, logging into an account (e.g., on a set top box, digital streaming device, mobile device), disarming a security system, voice recognition, and/or the like. If the user is recognized, one or more snapshots of thermal signatures of the user may be captured (e.g., at different times, different angles, using different devices). The one or more snapshots of thermal signatures may be used to train and/or refine a model (e.g., or a profile associated with the user, a profile associated with an account of the user, a thermal signature profile associated with the user, a thermal signature associated with an account). The one or more snapshots of thermal signatures may be used to identify features associated (e.g., by the machine learning model) with a particular user and/or account. The thermal signature and/or profile may be associated with other user features, such as a voice profile associated with the user, movement profile, content usage profile, and/or the like.

The thermal signature may be associated with a specific user. The thermal signature of the user may have characteristics specific to the user (e.g., height, shape). The thermal signature may be compared to any known thermal signatures associated with corresponding profiles. The machine learning model may be updated to recognize a specific user. If the thermal signature of the specific user changes over time, then the machine learning model may be trained based on updated thermal signatures associated with the user. If the thermal signature is matched to a specific person and/or a non-specific indication of a person, then a determination may be made that the thermal signature is indicative of user input and/or of a user (e.g., indicative of a person). If the thermal signature is matched to a non-human thermal signature, then a determination may be made that the thermal signature is not indicative of user input and/or of a user (e.g., indicative of a person).

If the thermal data and/or thermal signature is not indicative of a user (e.g., not indicative of a person), then the audio data from the source may be ignored by the voice controlled device 108. If the thermal data and/or thermal signature is indicative of a user (e.g., indicative of a person), then the audio data from the source may be processed by the voice controlled device 108. The audio data may be processed to determine a voice command (e.g., if not already determined at the time of receiving the audio). The voice command may be identified by converting the audio to text using speech to text recognition. The text may be analyzed to determine a trigger word (e.g., triggering word, key word, wake word) and/or any words following the trigger word. The words following the trigger word may be compared to a known list of commands. Words following the command may be determined as parameters for the preceding command. If a specific user is detected, permissions associated with the user may be verified to determine if the detected voice command is authorized.

The voice controlled device may cause execution of the command in a variety of ways. If the command relates to a specific device (e.g., the user device 106, the gateway device 104, the one or more premises devices 110), then the voice controlled device 108 may send an instruction to the device to cause the device to perform the instruction. In some scenarios, the voice controlled device 108 may not be configured to communicate directly with the device. An intermediary device (e.g., the gateway device 104, the server device 102, or other hub, controller) may be configured to control the device. The voice controlled device 108 may send the command and/or command parameters to the intermediary device, which may communicate the command and/or command parameters to the device associated with the command. A thermostat may be controlled via the gateway device 104 and/or server device 102. A television may be controlled directly (e.g., via direct wireless connection, or via the second network 114) by the voice controlled device. A speaker may be controlled directly (e.g., via direct wireless connection, or via the second network 114) by the voice controlled device.

The gateway device 104 may be configured to facilitate communication between the voice controlled device 108 and one or more of the server device 102, the user device 106, the one or more premises devices 110, or a combination thereof. The gateway device 104 may be configured to perform any of the features of the voice controlled device 108. The voice controlled device 108 may be entirely integrated into the gateway device 104. The gateway device 104 may perform processing of audio data, thermal data, and/or the like and provide decision logic for assisting the voice controlled device 108 in making determinations and communicating with other devices.

The gateway device 104 may function as a filter for commands intercepted (e.g., as a packet in transit to another device) from the voice controlled device 108. If a command is intercepted, the gateway device may perform any of the steps associated with the voice controlled device 108, such as receiving audio data, processing the audio data to determine location information, instruction devices to emit signals for detecting thermal data in the area associated with the location information, and processing the thermal data to identify if the thermal data is indicative of a user. If the gateway device 104 determines that thermal data is indicative of a user, the intercepted command may be sent to the intended destination. If the gateway device 104 determines that the thermal data is not indicative of a user, the intercepted command may be discarded and/or ignored. The voice controlled device 108 and/or gateway device may query the server device 102 for information and/or processing. Any of the steps and/or features of the gateway device 104 and/or the voice controlled device 108 may be performed by the server device 102 in response to a request to perform the specific processing, a request to process a voice command, and/or the like.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with the gateway device 104, the server device 102, the voice controlled device 108, the one or more premises devices 110, and/or the like. The user device 106 may be configured to output a user interface. The user interface may be output via the user interface via an application, service, and/or the like, such as a content browser. The user interface may receive application data from the server device 102. The application data may be processed by the user device 106 to cause display of the user interface.

The user interface may be displayed on a display of the user device 106. The display may comprise a television, screen, monitor, projector, and/or the like. The user interface may comprise a premises management application, a premises automation application, a content management application (e.g., for accessing video, audio, gaming, and/or other media), a smart assistant application, a virtual assistant application, a premises security application, network services application, or a combination thereof. The user interface may be configured to output status information associated with the premises (e.g., status information of the one or more premises device and/or gateway device 104). The application may be configured to allow control of and/or sending commands to the premises 116 (e.g., to the one more premises devices 110, the voice controlled device 108, and/or the gateway device 104). The user interface may be configured to allow a user to configure settings associated with the gateway device 104, the voice controlled device, and/or the like.

The gateway device 104 may be comprise a computing device, an access point (e.g., wireless access point), a router, a modem, device controller (e.g., automation controller, security controller, premises health controller, content device controller) a combination thereof, and/or the like. The gateway device 104 may be configured to communicate using the one or more second networks 114 at the premises 116. The gateway device 104 may be configured to implement one or more services associated with the server device 102 (e.g., or with the premises 116, a user account), such as a content service, a premises service, a voice controlled service, an automation service, a security service, a health monitoring service, or a combination thereof.

FIG. 2A shows a diagram of an example process for processing a voice command. The diagram shows an example premises 200 of a user 202. The premises 200 may comprise a plurality of rooms (e.g., or areas), such as a living room 204, a dining room 206, a kitchen 208, a bedroom 210, a bathroom 212, a foyer 214, and/or the like. The premises 200 may comprise a computing device 216, such as a voice controlled device, gateway device, virtual assistant device, controller (e.g., remote control), a speaker, a smart speaker, a combination thereof, and/or the like. The computing device 216 may be configured to communicate with one or more premises devices 218. The computing device 216 may communicate with the one or more premises devices 218 directly, via another computing device (e.g., router, gateway), via a local area network, via a wireless link, via a mesh network (e.g., comprising the plurality of premises devices 218), or a combination thereof.

The user 202 may speak a trigger word (e.g., triggering word, key word, wake word). The trigger word may be any keyword that is associated with providing a voice command. After speaking the trigger word, the user may speak the voice command. The computing device 216 may comprise one or more microphones. The computing device 216 may detect the spoken words of the user 202 as audio data. The computing device 216 may determine to attempt to identify location information associated with the user. The location information may comprise any location information associated with the premises 200, such as a location within the premises 200, a direction (e.g., with respect to the computing device 216, with respect to one or more of the premises device 218), a region (e.g., floor of the premises, group of rooms), an area (e.g., area within one or more rooms, patio), a room, or a portion of the room.

The computing device 216 may determine the location information based on the audio data and/or audio data from at least a portion of the one or more premises device 218. The computing device 216 may receive audio data from the one or more premises devices 218 (e.g., a door camera and a living room camera). The computing device 216 may analyze the audio data (e.g., from the one or more premises device 218 and/or from the microphone of the computing device 216) to determine intensity, loudness, noise level (e.g., decibel levels), and/or the like. An approximate distance and/or direction from the computing device (e.g., and/or the premises devices 218) may be determined. Intensity, loudness, noise level and/or the like may be associated with corresponding approximate distances. The computing device 216 may match the determined intensity, loudness, noise level, and/or the like with the corresponding distance. The associations of approximate distances with corresponding intensity, loudness, noise level, and/or the like may be specific to the user (e.g., or user profile).

The computing device 216 may be configured to determine the location information (e.g., direction, location within the premises 200) by performing a triangulation process using audio data from the one or more premises devices 218 and the computer device 216. The triangulation process may receive multiple inputs from audio data associated with different devices (e.g., the computing device 216, a first premises device, a second premises device). Each of the one or more premises devices 218 may have an associated location. A premises map (e.g., or premises location data) may comprise location information including distances, sizes, locations, and/or the like of rooms, the devices within the rooms, and/or the like. Each of the one or more premises devices 218 and the computing device 216 may have a known location within the premises map. The triangulation process may use the premises map to determine a location (e.g., pin point location) of a source of the audio data within the premises and/or other information, such as a direction and/or distance of the location compared to one or more of the computing device 216 and/or the one or more premises devices 218. The premises map may be determined based on lidar data, infrared data, accelerometer data, audio location data, and/or the like. The user 202 may use an application on a mobile device to generate the data for determining the premises map. The computing device 216 may use one or more sensors to map the room (e.g., based on audio signals, lidar, radar), and/or the like. If a premises map is not present, the triangulation process may estimate distances, directions, locations, and/or the like with respect to the computing device 216, the one or more premises devices 218, or a combination thereof.

The computing device 216, the one or more premises devices 218, or a combination thereof may transmit signals based on the location information. Single or multiple infrared beams from the one or more premises devices may be emitted (e.g., using beam streaming) in towards the location of the user 202. The computing device 216 may send an instruction to the one or more premises device 218 to cause the signals to be emitted. The instructions may indicate a configuration for beam forming (e.g., or beam steering) in a particular direction (e.g., based on the location information). The one or more premises devices 218 may comprise signal emitters, such as laser emitters, thermal signal emitters, infrared light emitters, light emitters, electromagnetic wave emitters, a combination thereof, and/or the like. The computing device 216 may also comprise the signal emitters. The one or more premises devices 218 and/or the computing device 216 may comprise signal detectors, such as sensors with one or more pixels. The one or more pixels may detect reflections of the emitters from the source (e.g., the user 202) of the audio. The one or more pixels may be organized according to spatial patterns, such as an array, a two-dimensional matrix, and/or the like. The resulting signal data may be an image, an array of values, a matrix of values, and/or the like.

The signal data may be sent to the computing device 216. The computing device 216 may be configured to process the signal data. In some scenarios, the signal data may be only signal data collected by sensors of the computing device. In some scenarios, the signal data may be only signal data collected by the one or more premises devices 218. In some scenarios, the signal data may comprise a combination of signal data from the computing device 216 and at least a portion of the one or more premises devices 218. The computing device 216 may process the signal data to determine a thermal signature of the source of the audio.

The computing device 216 may analyze the thermal signature to determine if the thermal signature is indicative of a user (e.g., indicative of a person, instead of a machine and/or speaker). One or more characteristics of the thermal signature may be analyzed to determine whether the thermal signature is indicative of a user. The one or more characteristics may comprise a temperature, a shape, a size, a movement, or a combination thereof. If the thermal signature indicates user input, the computing device 216 may determine to process the voice command detected in the audio data. If the thermal signature does not indicate user input, then the computing device 216 may ignore the audio data and/or voice command. The computing device may associate the thermal signature with a user profile and/or update a thermal signature already stored in the user profile.

FIG. 2B shows a diagram of an example process for processing a voice command. The premises 200 shown in FIG. 2B may comprise any of the features of the premises 200 of FIG. 2A. The premises 200 may further comprise one or more user devices, such as a mobile phone 220 (e.g., smart phone, cell phone), and a wearable device 222 (e.g., smart watch). In addition to or as an alternative to the one or more premises devices 218, the one or more user devices may be used to determine location information. The one or more user devices may comprise a GPS sensor, a wireless radio (e.g., or sensor), an accelerometer, and/or the like. The one or more user devices may be configured to detect the location of the user, such as a location within a premises, a room, area, zone, and/or the like. The computing device 216 may be configured to send a request to the one or more user devices for location information associated with the user. The computing device 216 may use beam steering techniques to determine a direction of wireless signals associated with the one or more user devices. The computing device 216 may be configured to receive the wireless signal and/or location information (e.g., GPS data, wireless location data), and/or any other sensor data associated with the user.

The one or more premises devices 218 may also provide location information that is not based on audio based detection of the source. The one or more premises devices 218 may comprise cameras. Images and/or video associated with the cameras may be processed (e.g., by the computing device 216, by the cameras) to determine a location of the user at the premises 200. The images and/or video may be processed to detect the presence of a person. If a person appears in an image of one camera and not the other, then the camera that detected the user may be used for thermal signature detection. The presence of the user in footage of one camera and not the other may be used to determine a direction, location, zone, room, and/or the like associated with the user.

The location information associated with the one or more premises devices 218 and/or the one or more user devices may be compared with each other and/or other location information, such as audio based location information. If comparison shows a mismatch, then it may be determined that the source of the audio is not the user. If the comparison shows a match, then it may be determined that the source of the audio is the user. A threshold may be used to determine whether location data from audio matches location information from the one or more user devices.

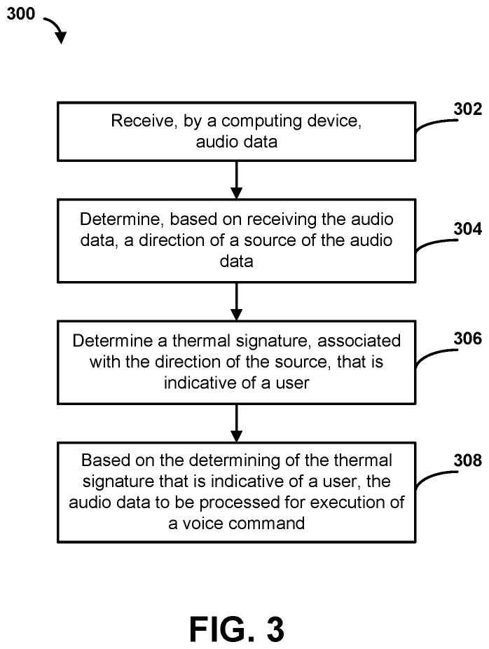

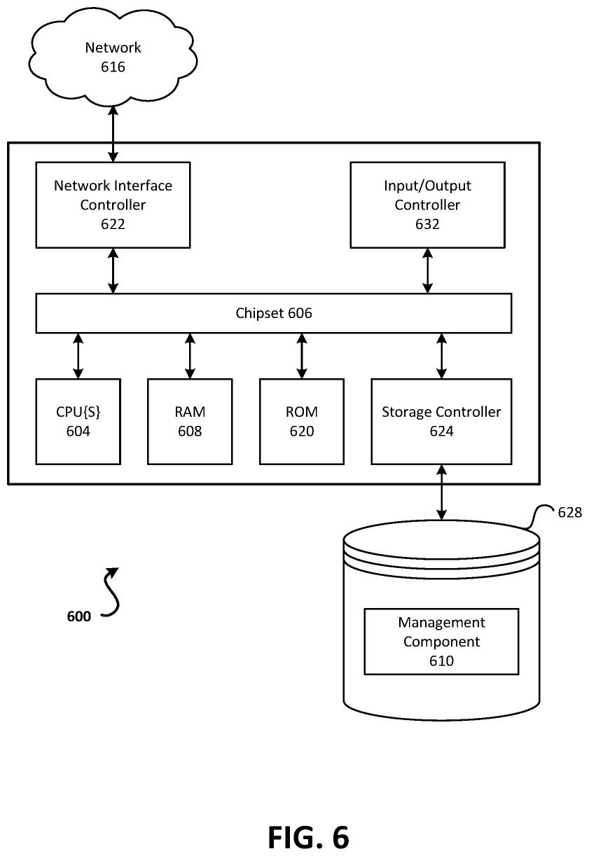

FIG. 3 is a flow diagram illustrating an example method. The method 300 may comprise a computer implemented method for providing a service (e.g., a communication service, network service, screening service, filtering service, spam service). A system and/or computing environment, such as the system 100 of FIG. 1 and/or the computing environment of FIG. 6, may be configured to perform the method 300.

At step 302, audio data may be received (e.g., captured). The audio data may be received by a voice controlled device (e.g., a voice enhanced device, a computing device, a gateway device, a control device). Receiving the audio data may comprise receiving the audio data using an array of microphones (e.g., disposed in the voice controlled device), a network of microphones (e.g., disposed throughout a premises). Receiving the audio data may comprise receiving the audio data by the voice controlled device and/or one or more of a remote control, a microphone, a camera device may comprise a microphone, a mobile device, or a wearable device.

At step 304, a direction of a source of the audio data may be determined (e.g., by the voice controlled device). The direction of a source of the audio data may be determined based on (e.g., in response to) receiving (e.g., capturing) the audio data. Determining the direction of the source may comprise determining (e.g., by the voice controlled device), based on spatial processing of the audio data from the array of microphones, the direction of the source.

The audio data may have variations due to the differing spatial relationship of the corresponding detector elements (e.g., array elements of a microphone) and/or device that collected the audio data. The audio data for each detector and/or device may be analyzed to determine spatial configuration information, such as estimated distance of the source to the detecting element, estimated direction (e.g., using the beamforming analysis), estimated angle (e.g., based on intensity of the audio), or a combination thereof. The spatial configuration information may be compared and/or combined among the different elements to determine the direction. In some scenarios, detecting the direction of the source may comprise performing a triangulation process. The triangulation process may combine the audio from different elements to determine the direction, distance, location, and/or the like of the source relative any device (e.g., detecting devices, the voice controlled device, the gateway device).

One or more devices may be caused (e.g., by the voice controlled device, by the gateway device, or a combination thereof) to emit and/or detect (e.g., or determine, capture, receive) one or more infrared signals in the direction of the source. The one or more devices may be caused, based on the determined direction of the source, to emit and/or detect one or more infrared signals in the direction of the source. The one or more devices that emit and/or detect the infrared signals may comprise one or more of an infrared device, an infrared sensor, an infrared camera, or a video camera.

Causing the one or more devices to emit and/or detect the one or more infrared signals in the direction of the source may comprise one or more of instructing a device configured to emit (e.g., or detect) signals in the direction to emit (e.g., or detect) infrared signals or causing the one or more devices to use beamforming to direct one or more infrared signals (e.g., or direction signal detectors) in the direction.

One or more messages may be sent to the one or more devices to cause emission of the one or more infrared signals and/or to configure the devices to detect signals from a particular direction. The one or more messages may comprise an approximate direction, elevation, angle, or a combination thereof relative to the emitting/detecting device. The messages may be sent via a gateway device to the one or more devices. The one or more messages may be sent directly (e.g., without using a gateway) to the one or more devices using one or more of a wide range of protocols, such as WIFI, ZIGB, NFC, Bluetooth, and/or the like.

At step 306, a thermal signature may be determined. The thermal signature may be associated with the direction of the source. The association may be based on the thermal signature being detected in the direction of the source, receiving signal data from the direction of the source, or a combination thereof. The thermal signature may be indicative of a user. Determining the thermal signature may comprise determining the that thermal signature is indicative of a user. The thermal signature may be determined based on causing the one or more devices to emit and/or detect the one or more infrared signals in the direction of the source. Determining the thermal signature may comprise receiving data indicative of one or more infrared signals. The data indicative of one or more infrared signals may be received by the computing device (e.g., by the voice controlled device, by the gateway device, or a combination thereof). The data indicative of the one or more infrared signals may be received from the one or more devices. Data indicative of the infrared signals may be received from each of the one or more devices. Determining the thermal signature may comprise analyzing the data indicative of the one or more infrared signals to one or more of determine the thermal signature or determine that the thermal signature is indicative of a user. Signal characteristics of the data indicative of the one or more infrared signals may be matched one or more known thermal signatures. The thermal signatures from each of the one or more devices may be combined to form a composite thermal signature. The data indicative of the thermal signature may comprise a single thermal signature, multiple thermal signatures, and/or a composite thermal signature.

One or more characteristics of the thermal signature (e.g., or the multiple thermal signatures, the composite thermal signature) may be analyzed to determine whether the thermal signature is indicative of a user. The one or more characteristics may comprise one or more of a temperature, a shape, a size, or a movement. A machine learning model (e.g., neural network) may be trained to recognize thermal signatures indicative of people.

The thermal signature may be associated with a specific user. The thermal signature of the user may have characteristics specific to the user (e.g., height, shape, area). The thermal signature may be compared to any known thermal signatures associated with corresponding profiles. The machine learning model may be updated to recognize a specific user. If the thermal signature of the specific user changes over time, then the machine learning model may be trained based on updated thermal signatures associated with the user.

If the thermal signature is matched to a specific person and/or a non-specific indication of a person, then a determination may be made that the thermal signature is indicative of user input and/or of a user (e.g., a person). If the thermal signature is matched to a non-human thermal signature, then a determination may be made that the thermal signature is not indicative of user input and/or of a user.

At step 308, the audio data may be caused (e.g., by the voice controlled device, by the gateway device, by a server, or a combination thereof) to be processed for execution of a voice command. The audio data may be caused to be processed for execution of a voice command based on the determination of the thermal signature indicative of the user (e.g., or based on a determination that thermal signature is indicative of a user). Causing the voice command to be executed may comprise causing, based on verifying that the user has permission to execute the voice command, the voice command to be executed. A user profile associated with the matching thermal signature may be accessed to determine any permissions associated with the user profile. If the user is not allowed to buy products, and the voice command is to buy a product, then the voice command may be ignored. The user may be allowed instead to play music. If the voice command is to play music, then the voice command may be processed.

Causing the audio data to be processed for execution of the voice command may comprise one or more of processing the audio data for a keyword and with the voice command, sending the voice command to an additional computing device, or sending the audio data to the additional computing device to determine the voice command. The voice controlled device may identify the voice command and (e.g., if needed) generate additional messages to various subsystems or other computing devices to cause the voice command to be executed.

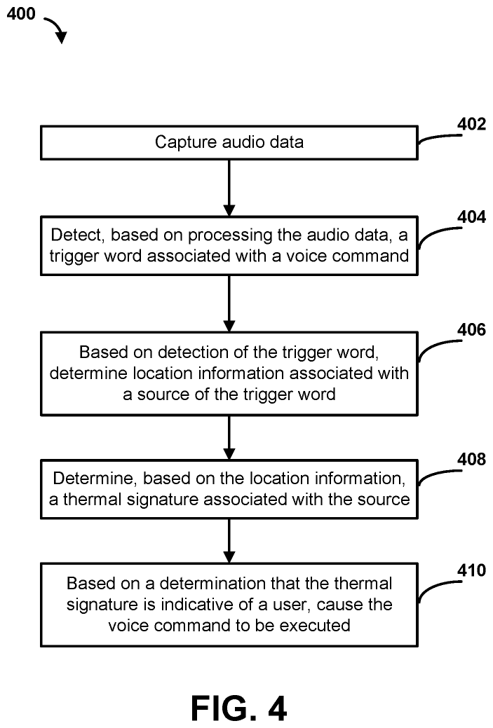

FIG. 4 is a flow diagram illustrating an example method. The method 400 may comprise a computer implemented method for providing a service (e.g., a communication service, network service, screening service, filtering service, spam service). A system and/or computing environment, such as the system 100 of FIG. 1 and/or the computing environment of FIG. 6, may be configured to perform the method 400.

At step 402, audio data may be received (e.g., captured, detected, by a computing device, gateway device, voice controlled device). Receiving the audio data may comprise receiving (e.g., capturing) the audio data from a plurality of devices located at a premises. The plurality of devices may comprise a voice controlled device, a camera (e.g., microphone of the camera), a remote controlled device, a gateway device, a user device (e.g., cell phone, smart phone, wearable device), a combination thereof, and/or the like. The plurality of devices may send the captured audio data to a computing device (e.g., the voice controlled device, the gateway, a server device).

At step 404, a trigger word (e.g., triggering word, wake word, key word) associated with a voice command may be determined (e.g., detected). The voice command may be determined by a computing device, gateway device, voice controlled device, a server, or a combination thereof. The trigger word associated with a voice command may be determined based on processing the audio data. The computing device may process the audio data based on speech to text processing, natural language processing, and/or the like. The audio data may be converted to text and compared to known trigger words. If a trigger word is determined, then the text may be further analyzed to determine any commands, command parameters, and/or the like associated with the trigger word.

At step 406, location information associated with a source of the trigger word may be determined (e.g., by a computing device, gateway device, voice controlled device, server). The location information associated with a source of the trigger word may be determined based on determining the trigger word. If a trigger word is determined, the computing device may determine to obtain location information associated with the source of the trigger word. The computing device may send messages (e.g., instructions) to one or more devices to cause the one or more devices to obtain location information.

Determining the location information may comprise determining the location information based on one or more of a global positioning sensor, a mobile device, a cell phone, or a wearable device. The computing device may send, via a network, messages to the global positioning sensor, the mobile device, the cell phone, the wearable device, a combination thereof, and/or the like. The global positioning sensor, the mobile device, the cell phone, the wearable device, and/or the like may be caused to generate sensor data and/or may retrieve already stored location data (e.g., or sensor data). These devices may generate signals, such as electromagnetic signals (e.g., wireless signals), location signals, and/or the like. The reflections and/or responses to the signals may be detected and stored as location information. The location information may be sent to the computing device (e.g., in response to the message and/or instruction from the computing device).

Determining the location information associated with the source may comprise triangulating, based on processing the audio data from the plurality of devices, the location information. The audio data collected by each of the plurality of devices may have variations due to the differing spatial relationship of the corresponding device to the source. The audio data for each device may be analyzed to determine spatial configuration information, such as estimated distance of the source to the detecting device, estimated direction (e.g., using the beamforming analysis), estimated angle (e.g., based on intensity of the audio). The spatial configuration information may be compared and/or combined among the plurality of devices to triangulate the location information.

At step 408, a thermal signature associated with the source may be determined (e.g., detected, by a computing device, gateway device, voice controlled device, server). The thermal signature associated with the source may be determined based on the location information. Determining the thermal signature associated with the source may comprise emitting, based on a direction indicated in the location information, an infrared signal. The computing device may analyze the location information to determine a direction (e.g., or area, zone, room, pinpoint location, coordinate) of the source with respect to the computing device, and/or other device (e.g., camera, infrared camera). The location information may comprise spatial configuration information that may be analyzed with respect to a particular device to determine a spatial relationship (e.g., direction, distance) between the device and the source. The location information may be combined with mapping information, such as a premises map, GPS data, wireless range data (e.g., Bluetooth range, Wi-Fi connected range, ZigBee distance), and/or the like. The mapping information may be used to relate the location information to a coordinate space relative to a premises and/or relative to the particular device.

One or more devices may be selected based on the direction (e.g., or area, zone, room, pinpoint location, coordinate). The mapping information may indicate locations, orientations, distances, angles, and/or other information specific to devices positioning at a premises. A device may be selected if it is oriented (e.g., has a sensor aimed) towards the location (e.g., or direction). A device may be selected based on a map (e.g., or mapping data) providing geospatial relationships of devices, rooms, floors, areas, and/or the like. If the device is in the same area, zone, room, and/or the like as the location, then it may be selected. The selected devices may be instructed (e.g., via messages sent over a network) to emit one or more signals, such as infrared signals, thermal signals, and/or the like.

Determining the thermal signature may comprise detecting (e.g., or determining, capturing), based on the emitted infrared signal, the thermal signature. The selected devices may detect reflections of the emitted signals. The reflections may indicate and/or emphasize variations in thermal intensity values across an image (e.g., from a plurality of pixels). A thermal signature may be identified by performing automated boundary identification. Boundaries may be determined where intensity values vary more than a threshold amount.

At step 410, the voice command may be caused to be executed (e.g., by a computing device, gateway device, voice controlled device, server). The voice command may be caused to be executed based on a determination that the thermal signature is indicative of user input. One or more characteristics of the thermal signature may be analyzed to determine whether the thermal signature is indicative of a user (e.g., person). The one or more characteristics may comprise one or more of a temperature, a shape, a size, or a movement. The thermal signature may have a shape, size, movement pattern, average intensity value (e.g., corresponding to a temperature), or a combination thereof. Feature recognition may be performed to identify human and/or non-human characteristics of the thermal signature. If the recognized features match a characteristics of a human, then a determination may be made that the thermal signature is indicative of a user. If the thermal signature is indicative of a user, a determination may be made to execute the voice command. Otherwise, if the thermal signature is determined to not be indicative of a user, a determination may be made to not execute the voice command.

Causing the voice command to be executed may comprise one or more of sending an instruction to a voice controlled device to process the audio data (e.g., if the computing device is not the voice controlled device), sending data indicative of the voice command to a computing device (e.g., a server, television, content device, speaker) configured to execute the voice command, or authorizing data indicative of the voice command to be transmitted via a network (e.g., if the computing device is a gateway device it may act as a filter for messages sent by a voice controlled device). The thermal signature may be associated with a specific user. Causing the voice command to be executed may comprise causing, based on verifying that the user has permission to execute the voice command, the voice command to be executed.

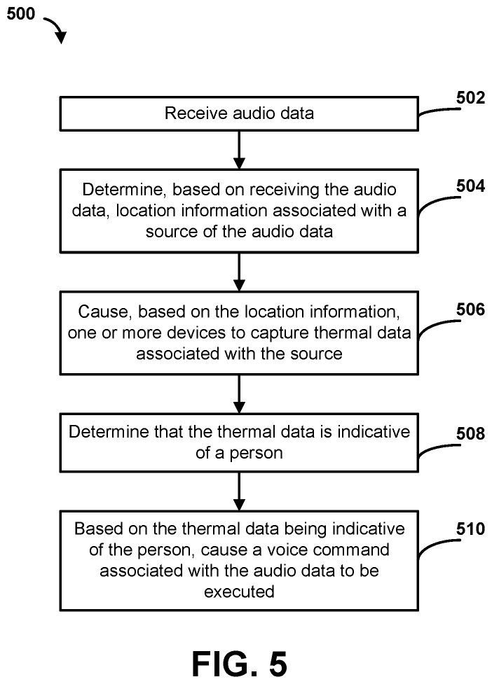

FIG. 5 is a flow diagram illustrating an example method. The method 500 may comprise a computer implemented method for providing a service (e.g., a communication service, network service, screening service, filtering service, spam service). A system and/or computing environment, such as the system 100 of FIG. 1 and/or the computing environment of FIG. 6, may be configured to perform the method 500.

At step 502, audio data may be received. The audio data may be received by a gateway device. Receiving the audio data may comprise receiving the audio data from a plurality of devices located at a premises. The plurality of devices may comprise a voice controlled device, a remote control, a microphone, a camera device comprising a microphone, a mobile device, a wearable device, a speaker, or a combination thereof. The audio data may comprise, for example, audio from microphones of two different cameras and audio from a voice controlled device. In some scenarios, the gateway device may comprise the voice controlled device. If a device has an array of microphones of a single device, audio data may be received and associated with each microphone.

At step 504, location information associated with a source of the audio data may be determined (e.g., by the gateway device). The location information associated with a source of the audio data may be determined based on receiving the audio data. Determining the location information associated the source may comprise triangulating, based on processing the audio data from the plurality of devices, one or more of a location, a direction, a region, an area, a room, or a portion of the room. The gateway device may perform spatial processing of the audio data to determine or one or more of a direction or a location of the source of the audio data. In some scenarios, the gateway device may send the audio data to a server located external to the premises to perform the spatial processing. The spatial processing may indicate, a location (e.g., room, zone, area) within a premises map, a direction with respect to one or more of the plurality of devices, a devices of the plurality of devices closest and/or more likely to be oriented in the direction of the source, a combination thereof, and/or the like.

At step 506, one or more devices may be caused (e.g., by the gateway device) to capture (e.g., or receive, determine) thermal data associated with the source. The one or more devices may be caused to capture thermal data associated with the source based on the location information. The one or more devices may be selected (e.g., by the gateway device, or by a server in communication with the gateway device) based on a direction, area, zone, room, pinpoint location, coordinate, and/or the like associated with the source (e.g., in the determined location information). A device may be selected if it is oriented (e.g., has a sensor aimed) towards the location (e.g., or direction). A device may be selected based on a map (e.g., or mapping data) providing geospatial relationships of devices, rooms, floors, areas, and/or the like. If the device is in the same area, zone, room, and/or the like as the location associated the source, then the device may be selected.

Causing the one or more devices to capture thermal data associated with the source may comprise sending an instruction to emit (e.g., and/or detect), based on location information, an infrared signal. The selected devices may be instructed (e.g., via messages sent over a network) to emit and/or detect one or more signals, such as infrared signals, thermal signals, and/or the like. The one or more devices may receive, based on the emitted and/or detected infrared signal (e.g., or multiple signals), the thermal data. The thermal data may comprise intensity values. The intensity values may be organized as pixels in an image. The intensity values may indicate different temperatures detected by a sensor (e.g., each pixel may detect a different value). The thermal data may be sent to the gateway device.

At step 508, a determination may be made (e.g., by the gateway device) that the thermal data is indicative of a person. Determining that the thermal data may be indicative of the person may comprise analyzing one or more characteristics of the thermal data to determine whether the thermal data is indicative of a person. The one or more characteristics may comprise one or more of a temperature, a shape, a size, or a movement. The thermal data may have a shape, size, movement pattern, average intensity value (e.g., corresponding to a temperature), or a combination thereof. Feature recognition may be performed to identify human and/or non-human characteristics of the thermal data. If the recognized features match a characteristics of a human, then a determination may be made to execute the voice command. Otherwise, a determination may be made to not execute the voice command.

At step 510, a voice command associated with the audio data may be caused (e.g., by the gateway device, by a voice controlled device, by a server, or a combination thereof) to be executed. The voice command associated with the audio data may be caused to be executed based on the thermal data being indicative of the person (e.g., or a determination that the thermal data is indicative of a person). Causing the voice command associated with the audio data to be executed may comprise one or more of sending an instruction to a voice controlled device to process the audio data, sending data indicative of the voice command to a computing device configured to execute the voice command, or authorizing data indicative of the voice command to be transmitted via a network. The thermal data may be associated with a specific user. Causing the voice command associated with the audio data to be executed may comprise causing, based on verifying that the user has permission to execute the voice command, the voice command to be executed.

FIG. 6 depicts a computing device that may be used in various aspects, such as the servers and/or devices depicted in FIGS. 1, and 2A-B. With regard to the example architecture of FIG. 1, the server device 102, gateway device 104, user device 106, the voice controlled device 108, and the one or more premises devices 110 may each be implemented in an instance of a computing device 600 of FIG. 6. With regard to the example architecture of FIG. 2A-B, the computing device 216, the one or more premises devices 218, the mobile phone 220, and the wearable device 222 may each be implemented in an instance of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIG. 2A-B, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIG. 2A-B, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving, by a computing device, audio data;
determining, based on receiving the audio data, a direction of a source of the audio data;
determining a thermal signature, associated with the direction of the source, that is indicative of a user; and
based on the determining of the thermal signature that is indicative of a user, causing the audio data to be processed for execution of a voice command.

2. The method of claim 1, wherein receiving the audio data comprises capturing the audio data using an array of microphones, and wherein determining the direction of the source comprises determining, based on spatial processing of the audio data from the array of microphones, the direction of the source.

3. The method of claim 1, further comprising causing one or more devices to detect one or more infrared signals in the direction of the source, wherein determining the thermal signature comprises determining, based on the one or more infrared signals, the thermal signature.

4. The method of claim 1, further comprising analyzing one or more characteristics of the thermal signature to determine whether the thermal signature is indicative of a user, wherein the one or more characteristics comprises one or more of a temperature, a shape, a size, or a movement.

5. The method of claim 1, wherein the thermal signature is associated with a specific user, wherein causing the voice command to be executed comprises causing, based on verifying that the user has permission to execute the voice command, the voice command to be executed.

6. The method of claim 1, wherein causing the audio data to be processed for execution of the voice command comprises one or more of processing the audio data for a keyword and with the voice command, sending the voice command to an additional computing device, or sending the audio data to the additional computing device to determine the voice command.

7. The method of claim 1, wherein determining the thermal signature comprises receiving, from one or more devices, data indicative of one or more infrared signals and analyzing the data indicative of the one or more infrared signals to one or more of determine the thermal signature or determine that the thermal signature is indicative of a user.

8. A method comprising:
receiving audio data;
detecting, based on processing the audio data, a trigger word associated with a voice command;
based on detection of the triggering word, determining location information associated with a source of the trigger word;
determining, based on the location information, a thermal signature associated with the source; and
based on a determination that the thermal signature is indicative of a user, causing the voice command to be executed.

9. The method of claim 8, wherein determining the location information comprises determining the location information based on one or more of a global positioning sensor, a mobile device, a cell phone, or a wearable device.

10. The method of claim 8, wherein receiving the audio data comprises capturing the audio data from a plurality of devices located at a premises, wherein determining the location information associated with the source comprises triangulating, based on processing the audio data from the plurality of devices, the location information.

11. The method of claim 8, wherein determining the thermal signature associated with the source comprises emitting, based on a direction indicated in the location information, an infrared signal and detecting, based on the emitted infrared signal, the thermal signature.

12. The method of claim 8, further comprising analyzing one or more characteristics of the thermal signature to determine whether the thermal signature is indicative of a person, wherein the one or more characteristics comprise one or more of a temperature, a shape, a size, or a movement.

13. The method of claim 8, wherein the thermal signature is associated with a specific user, wherein causing the voice command to be executed comprises causing, based on verifying that the user has permission to execute the voice command, the voice command to be executed.

14. The method of claim 8, wherein causing the voice command to be executed comprises one or more of sending an instruction to a voice controlled device to process the audio data, sending data indicative of the voice command to a computing device configured to execute the voice command, or authorizing data indicative of the voice command to be transmitted via a network.

15. A method comprising:
receiving, by a gateway device, audio data;
determining, based on receiving the audio data, location information associated with a source of the audio data;
causing, based on the location information, one or more devices to capture thermal data associated with the source;
determining that the thermal data is indicative of a person; and
based on the thermal data being indicative of the person, causing a voice command associated with the audio data to be executed.

16. The method of claim 15, wherein receiving the audio data comprises receiving the audio data from a plurality of devices located at a premises, wherein determining the location information associated the source comprises triangulating, based on processing the audio data from the plurality of devices, one or more of a location, a direction, a region, an area, a room, or a portion of the room.

17. The method of claim 15, wherein causing the one or more devices to capture thermal data associated with the source comprises sending an instruction to emit, based on location information, an infrared signal, wherein the one or more devices receive, based on the emitted infrared signal, the thermal data and send the thermal data to the gateway device.

18. The method of claim 15, wherein determining that the thermal data is indicative of the person comprises analyzing one or more characteristics of the thermal data to determine whether the thermal data is indicative of a person, wherein the one or more characteristics comprise one or more of a temperature, a shape, a size, or a movement.

19. The method of claim 15, wherein the thermal data is associated with a specific user, wherein causing the voice command associated with the audio data to be executed comprises causing, based on verifying that the specific user has permission to execute the voice command, the voice command to be executed.

20. The method of claim 15, wherein causing the voice command associated with the audio data to be executed comprises one or more of sending an instruction to a voice controlled device to process the audio data, sending data indicative of the voice command to a computing device configured to execute the voice command, or authorizing data indicative of the voice command to be transmitted via a network.
